(19) United States
(12) Patent Application Publication
(10) Pub. No.: US 2006/0250177 A1
(43) Pub. Date: Nov. 9, 2006

(54) Methods and apparatus for dynamically reconfiguring a charge pump during output transients

(76) Inventors: Tyler J. Thorp, Sunnyvale, CA (US); Kenneth K. So, Belmont, CA (US); Roy E. Scheuerlein, Cupertino, CA (US)

Correspondence Address: LAW OFFICE OF JAMES TROSINO, 92 NATOMA STREET, SUITE 211, SAN FRANCISCO, CA, 94105, US

(21) Appl. No.: 11/125,000

(22) Filed: May 9, 2005

(51) Int. Cl. G05F 1/10

(52) U.S. Cl. 327/536

(57) ABSTRACT

Methods and apparatus are described for dynamically controlling a charge pump system including a plurality of charge pump stages, with each charge pump stage coupled between an input voltage V_{IN} at an input voltage node and an output voltage V_{OUT} at an output voltage node. In particular, the configuration of the charge pump stages may be dynamically controlled during a transition on V_{OUT} from a first voltage to a second voltage to improve the circuit's transient response.

### BACKGROUND

Many integrated circuits require multiple power supply voltage levels for normal device operation. For example, an integrated circuit may contain certain types of semiconductor memories that require a “write voltage” of about 8 volts, yet other operations of the memory circuits, including “read” operations, require a voltage of only about 3 volts. In the past, two different power supplies often would be used to operate such a device. Today, however, such integrated circuits typically require only a single power supply voltage, and include on-chip circuitry to generate a “boosted” voltage having a magnitude greater than the power supply voltage. For example, many modern integrated circuits use a single power supply voltage V_{DD} of about 2.5-3.3 volts to power most of the device, including the normal read operation circuits, and also include an on-chip voltage generator that provides a boosted voltage V_{PP} of about 8 volts for write operations. Such on-chip voltage generators are often implemented as capacitive voltage multiplier circuits commonly called “charge pumps.”

Referring now to FIG. 1, an exemplary previously known multi-stage charge pump is described. Charge pump 10 includes charge pump stages 12a-12d coupled in series between input voltage V_{IN} and output voltage V_{OUT}. Charge pump stages 12a-12d each include a charge transfer device, such as diodes 14a-14d, respectively, and a pump capacitor, such as capacitors C_{A}-C_{D}, respectively. A complementary pair of non-overlapping clock signals CLK and \overline{CLK} are provided to drive the various pump capacitors. In particular, charge pump stages 12a and 12c are driven by the CLK signal, whereas pump stages 12b and 12d are driven by the CLK signal. Isolation diode 16 couples the output of the final charge pump stage 12d to output node V_{OUT}, which is shown with a capacitive load C_{LOAD} coupled to GROUND. If clock signals CLK and CLK are driven by signals that swing between a high level of V_{IN} and a low level of GROUND, charge pump circuit 10 generates an output voltage V_{OUT} that is boosted above V_{IN}. The price paid for achieving an increased output voltage, however, is higher input current requirements.

For some circuit applications, such as in memory devices, the transient response of the charge pump is one of the factors that limit how fast the memory can be read or written. To provide faster read and write times, therefore, it often is desirable to reduce the charge pump's transient response time. The transient response time of charge pump 10 may be reduced by increasing output current I_{OUT}. As mentioned above, however, increasing the output current further increases input current I_{IN}. For some circuit applications, input current is limited, which thus limits the amount by which the charge pump's output current can be increased to improve the circuit's transient response.

One previously known technique for overcoming this limitation is to taper the capacitors used in each charge pump stage. That is, referring again to FIG. 1, the size of pump capacitors C_{A}-C_{D} may be tapered so that C_{A}>C_{B}>C_{C}>C_{D}. In steady-state, however, the current in stages 12a-12d are equal, and are limited by the current-capacity of the smallest stage. Thus, if C_{D}=C, the steady-state output current of charge pump 10 with tapered pump capacitors is approximately equal to the circuit with non-tapered capacitors. Therefore, although increasing the size of pump capacitor C_{A} helps improve the transient response of charge pump 10, this large capacitor does not add any additional steady-state current capacity, and merely consumes a large amount of area on the integrated circuit.

In view of the foregoing, it would be desirable to provide methods and apparatus that improve the transient response of a charge pump circuit without increasing capacitor size.

It further would be desirable to provide methods and apparatus that improve the transient response of a charge pump circuit without exceeding input current limits.

### SUMMARY

Methods and apparatus in accordance with this invention control a charge pump system comprising a plurality of charge pump stages, with each charge pump stage coupled between an input voltage V_{IN} at an input voltage node and an output voltage V_{OUT} at an output voltage node. In one exemplary embodiment, the configuration of the charge pump circuits are changed during a transition on V_{OUT} from a first voltage to a second voltage to improve the circuit's transient response.

In particular, the number of charge pump stages coupled to the input voltage node and the output voltage node may be dynamically changed during the transition on V_{OUT} from the first voltage to the second voltage. A first plurality of charge pump stages may be coupled to the input voltage node and the output voltage node to increase V_{OUT} to a first intermediate voltage between the first and second voltages, and then a second plurality of charge pump stages may be coupled to the input voltage node and the output voltage node to increase V_{OUT} to a second intermediate voltage between the first and second voltages. Alternatively, a first plurality of charge pump stages may be coupled to the input voltage node and the output voltage node to increase V_{OUT} to a first intermediate voltage between the first and second voltages, and then a second plurality of charge pump stages may be coupled to the input voltage node and the output voltage node to increase V_{OUT} to the second voltage.

In an alternative exemplary embodiment, the frequency of the clock signals supplied to the charge pump stages may be dynamically changed during the transition on V_{OUT} from the first voltage to the second voltage. In particular, clock signals at a first frequency are provided to the charge pump stages to increase V_{OUT} to a first intermediate voltage between the first and second voltages, and then clock signals at a second frequency may be provided to the charge pump stages to increase V_{OUT} to a second intermediate voltage between the first and second voltages.

In another exemplary embodiment, the pump capacitor values in the charge pump stages may be dynamically changed during the transition on V_{OUT} from the first voltage to the second voltage. In particular, a first plurality of charge pump stages having a first set of pump capacitor values may be coupled to the input voltage node and the output voltage node to increase V_{OUT} to a first intermediate voltage between the first and second voltages, and then a second plurality of charge pump stages having a second set of pump capacitor values may be coupled to the input voltage node and the output voltage node to increase V_{OUT} to the second voltage. The first or second set of pump capacitor values may be tapered values.

### BRIEF DESCRIPTION OF THE DRAWINGS

The above-mentioned objects and features of the present invention can be more clearly understood from the following detailed description considered in conjunction with the following drawings, in which the same reference numerals denote the same elements throughout, and in which:

FIG. 1 is a diagram of a previously known charge pump;

FIG. 2 is a diagram of an exemplary dynamically reconfigurable charge pump in accordance with this invention;

FIG. 3 is a diagram of exemplary output current versus output voltage response curves for various exemplary charge pump configurations;

FIG. 4A is a diagram of an exemplary configuration of the circuit of FIG. 2 during a first exemplary time interval;

FIG. 4B is a diagram of an exemplary configuration of the circuit of FIG. 2 during a second exemplary time interval;

FIG. 4C is a diagram of an exemplary configuration of the circuit of FIG. 2 during a third exemplary time interval;

FIG. 4D is a diagram of an exemplary configuration of the circuit of FIG. 2 during a fourth exemplary time interval; and

FIG. 5 is a diagram of an exemplary control system for use with dynamically reconfigurable charge pumps in accordance with this invention.

### DETAILED DESCRIPTION

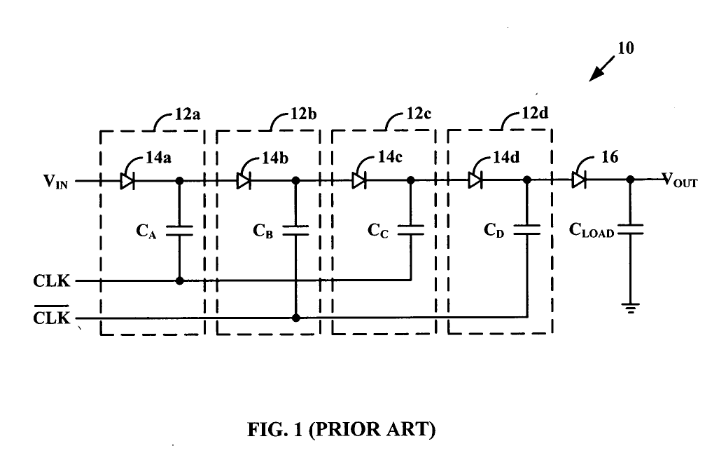

Referring again to FIG. 1, if pump capacitors C_{A}-C_{D} all have the same value C, if second-order effects are ignored, and assuming ideal diodes having a threshold voltage of 0V, the output voltage and output current of charge pump 10 may be expressed as:
V_{OUT}(t)=(n+1)V_{IN}−n(ΔV(t)) (1)
I_{OUT}(t)=C(ΔV(t))f_{clk} (2)
where n is the number of series-coupled charge pump stages 12a-12d, ΔV(t) is the voltage change per charge pump stage 12a-12d, and f_{clk} is the clock frequency of clock signals CLK and \overline{CLK}.

The price paid for achieving an increased output voltage, however, is higher input current requirements. In particular, if second-order effects are ignored, the input current of charge pump 10 may be expressed as:
I_{IN}(t)=(n+1)I_{OUT}(t) (3)

The transient response time of charge pump 10 may be reduced by increasing output current I_{OUT}. As indicated by equation (3), however, each 1-unit increase in output current I_{OUT} requires an (n+1)-unit increase in input current I_{IN}. For some circuit applications, input current is limited, which thus limits the amount by which the charge pump's output current can be increased to improve the circuit's transient response.

One previously known technique for overcoming this limitation is to taper the capacitors used in each charge pump stage. That is, referring again to FIG. 1, the size of pump capacitors C_{A}-C_{D} may be tapered so that C_{A}>C_{B}>C_{C}>C_{D}. In steady-state, however, the current in stages 12a-12d are equal, and are limited by the current-capacity of the smallest stage:
I_{OUT}(t)=C_{D}ΔV(t)f_{clk} (4)

Thus, if C_{D}=C, the steady-state output current of charge pump 10 with tapered pump capacitors is approximately equal to the circuit with non-tapered capacitors. Therefore, although increasing the size of pump capacitor C_{A} helps improve the transient response of charge pump 10, this large capacitor does not add any additional steady-state current capacity, and merely consumes a large amount of area on the integrated circuit.

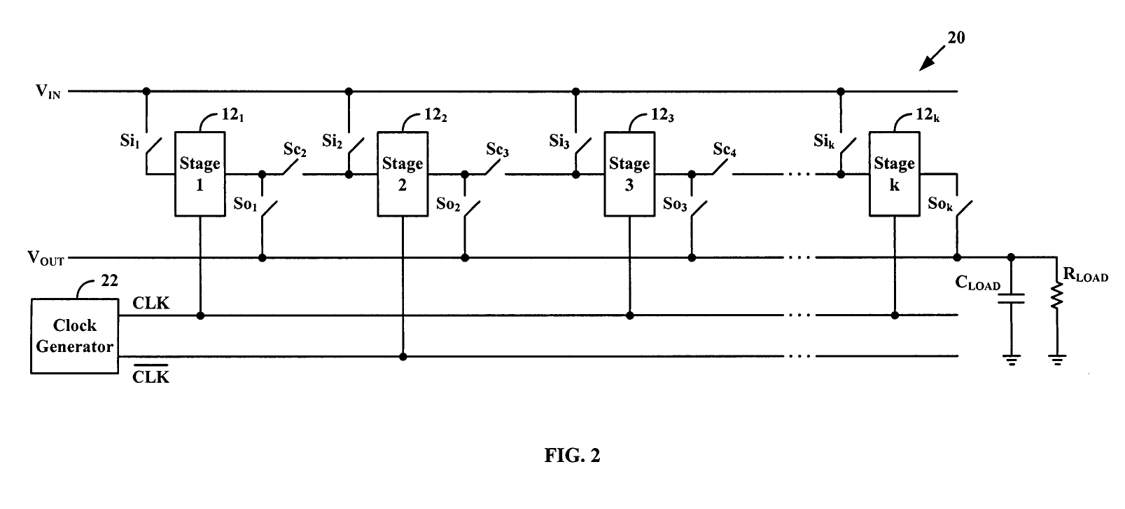

Methods and apparatus in accordance with this invention change the configuration of the charge pump during a transition on V_{OUT} from a first voltage to a second voltage to improve the circuit's transient response. Referring now to FIG. 2, an exemplary dynamically configurable charge pump in accordance with this invention is described. In particular, charge pump 20 includes k charge pump stages 12₁, 12₂, . . . , 12ₖ, and clock generator 22. Each charge pump stage 12₁, 12₂, . . . , 12ₖ is coupled to input node V_{IN} via a corresponding input switch Si₁, Si₂, . . . , Siₖ, respectively, and to output node V_{OUT} via a corresponding output switch So₁, So₂, . . . , Soₖ, respectively. Further, each of charge pump stages 12₂, 12₃, . . . , 12ₖ is coupled to the immediately preceding stage by a corresponding coupling switch Sc₁, Sc₂, . . . , Scₖ, respectively. Although not shown in FIG. 2, each charge pump stage 12₁, 12₂, . . . , 12ₖ includes corresponding pump capacitor C₁, C₂, . . . , Cₖ, respectively. Clock generator 22 generates non-overlapping clock signals CLK and \overline{CLK} at a frequency f_{clk0}, and that are alternately applied to charge pump stage 12₁, 12₂, . . . , 12ₖ.

Input switches Si₁, Si₂, . . . , Siₖ, output switches So₁, So₂, . . . , Soₖ, and coupling switches Sc₁, Sc₂, . . . , Scₖ may be used to modify the configuration of charge pump stages 12₁, 12₂, . . . , 12ₖ. For example, if input switches Si₁, Si₂, . . . , Siₖ are all CLOSED, output switches So₁, So₂, . . . , Soₖ are all CLOSED and coupling switches Sc₁, Sc₂, . . . , Scₖ are all OPEN, charge pump stages 12₁, 12₂, . . . , 12ₖ are all coupled in parallel between input node V_{IN} and output node V_{OUT}. Alternatively, if input switch Si₁, coupling switches Sc₂, Sc₃, . . . , Scₖ, and output switch Soₖ are all CLOSED, and all other switches are OPEN, charge pump stages 12₁, 12₂, . . . , 12ₖ are all coupled in series between input node V_{IN} and output node V_{OUT}.

Further, input switches Si₁, Si₂, . . . , Siₖ, output switches So₁, So₂, . . . , Soₖ, and coupling switches Sc₁, Sc₂, . . . , Scₖ may be independently programmed to couple any number of charge pump stages 12₁, 12₂, . . . , 12ₖ in series or parallel. Thus, if switches Si₁, Sc₂ and So₂ are CLOSED, and all other switches are OPEN, charge pump stages 12₁ and 12₂ are coupled in series between input node V_{IN} and output node V_{OUT}, and all other charge pump stages 12₃, . . . , 12ₖ are disconnected. Alternatively, if switches Si₁, Si₂, Si₃, So₁, So₂ and So₃ are OPEN, and all other switches are closed, charge pump stages 12₁, 12₂ and 12₃ are coupled in parallel between input node V_{IN} and output node V_{OUT}, and all other charge pump stages 12₄, . . . , 12ₖ are disconnected.

As used herein, i charge pump stages 12₁, 12₂, . . . , 12ᵢ coupled in series are referred to as an ith-order charge pump, with n=i. Thus, a first-order charge pump includes a single charge pump stage 12₁, with n=1. In contrast, a fourth-order charge pump includes four series-coupled charge pump stages 12₁, 12₂, 12₃, 12₄, with n=4.

In accordance with an embodiment of this invention, input switches Si₁, Si₂, . . . , Siₖ, output switches So₁, So₂, . . . , Soₖ, and coupling switches Sc₁, Sc₂, . . . , Scₖ may be dynamically controlled to change the configuration of charge pump stages 12₁, 12₂, . . . and 12ₖ during a transition on V_{OUT} to improve the transient response of charge pump 20. In general, during a transition on V_{OUT} from a first voltage V_{A} to a second voltage V_{B}, the series/parallel configuration of m charge pump stages 12₁, 12₂, . . . , 12ₘ may be dynamically reconfigured as follows:

TABLE 1

| Time | Configuration | n | ΔV_{OUT} |
|---|---|---|---|
| 0 ≦ t < t₁ | m first-order charge pumps | 1 | V_{A} to V₁ |
| | coupled in parallel | | |
| t₁ ≦ t < t₂ | m/2 second-order charge pumps | 2 | V₁ to V₂ |
| | coupled in parallel | | |
| t₂ ≦ t < t₃ | m/3 third-order charge pumps | 3 | V₂ to V₃ |
| | coupled in parallel | | |
| t₃ ≦ t < t₄ | m/4 fourth-order charge pumps | 4 | V₃ to V₄ |
| | coupled in parallel | | |
| . . . | . . . | . . . | . . . |
| tⱼ₋₁ ≦ t < tⱼ | 1 mth-order charge pump | m | Vⱼ₋₁ to V_{B} |

That is, during a first time interval 0≦t<t₁, m first-order charge pumps may be coupled in parallel to increase V_{OUT} from V_{A} to V₁; during a second time interval t₁≦t<t₂, m/2 second-order charge pumps may be coupled in parallel to increase V_{OUT} from V₁ to V₂; during a third time interval t₂≦t<t₃, m/3 third-order charge pumps may be coupled in parallel to increase V_{OUT} from V₂ to V₃, and so on until during a jth time interval tⱼ₋₁≦t<tⱼ, a single mth-order charge pump may be used to increase V_{OUT} from Vⱼ₋₁ to V_{B}. Persons of ordinary skill in the art will understand that the number m of charge pump stages and the number j of time intervals may be the same, or may be different.

In contrast to previously known techniques that use a single mth-order charge pump to increase V_{OUT} from V_{A} to V_{B}, methods and apparatus in accordance with this embodiment of the invention dynamically reconfigure charge pump 20 from lower-order configurations to higher-order configurations during a transition on V_{OUT}. In this regard, during the initial period of the voltage transient, multiple lower-order charge pumps are coupled in parallel to boost the output current, while maintaining relatively modest input current requirements.

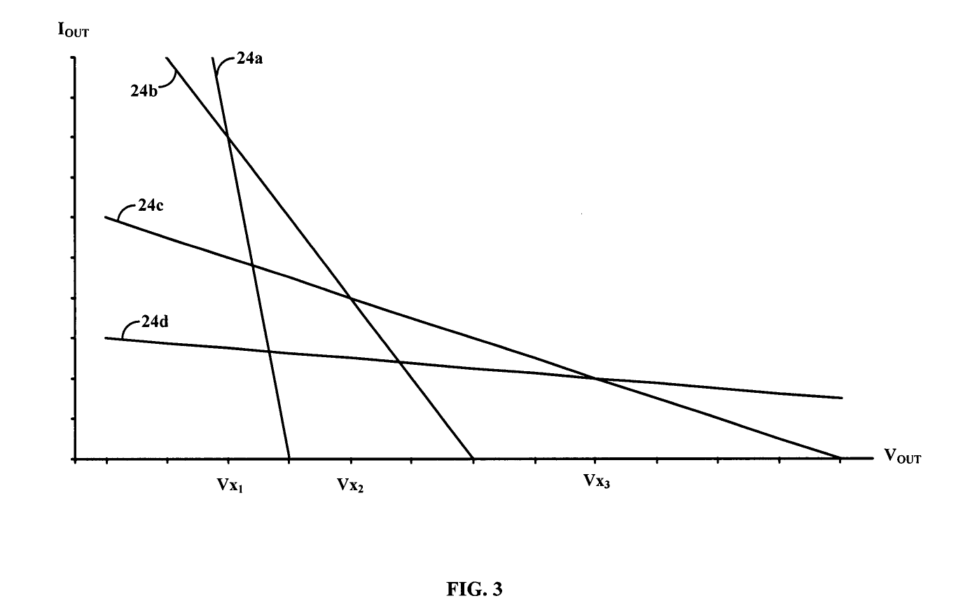

Various techniques may be used to determine when and how charge pump 20 should be reconfigured. For example, charge pump 20 may be dynamically reconfigured to maximize output current I_{OUT}. In particular, FIG. 3 illustrates exemplary output current I_{OUT} versus output voltage V_{OUT} response curves 24a-24d for ith-order, jth-order, kth-order and lth-order charge pump configurations, respectively, where i<j<k<1. As the diagram illustrates, for V_{OUT} less than Vx₁, the ith-order charge pump provides the maximum output current I_{OUT}. For Vx₁<V_{OUT}≦Vx₂, the jth-order charge pump provides the maximum output current I_{OUT}. For Vx₂≦V_{OUT}<Vx₃, the kth-order charge pump provides the maximum output current I_{OUT}. And for V_{OUT}≧Vx₃, the lth-order charge pump provides the maximum output current I_{OUT}. Thus, to maximize output current during a transition on V_{OUT}, charge pump 20 may be switched from a lower-order configuration to a higher-order configuration when the higher-order configuration provides greater output current I_{OUT}. The value of V_{OUT} at which the circuit reconfiguration occurs is referred to herein as the “crossover voltage.”

Thus, from Table 1, above, charge pump 20 may be switched from the first-order configuration to the second-order configuration at crossover voltage V₁, at which point the output current I_{OUT} of the second-order configuration exceeds the output current of the first-order configuration. Similarly, charge pump 20 may be switched from the second-order configuration to the third-order configuration when V_{OUT} reaches crossover voltage V₂, at which point the output current I_{OUT} of the third-order configuration exceeds the output current of the second-order configuration. Because the dynamically reconfigured charge pump 20 maintains high output current I_{OUT}, the circuit can achieve a shorter transient response time than a comparable previously known static charge pump.

Persons of ordinary skill in the art will understand that all configurations need not be used. For example, if m=8, the first-order configuration may be used until V_{OUT} reaches a first crossover voltage, the second-order configuration may be used until V_{OUT} reaches a second crossover voltage, the fourth-order configuration may be used until V_{OUT} reaches a third crossover voltage, and the eighth-order configuration may be used until V_{OUT} reaches the final desired output voltage.

The crossover voltage at which m/b, bth-order charge pump stages provide greater output current I_{OUT} than m/a, ath-order charge pump stages (b>a) may be determined using the following equation:

$${V}_{xover} = {V}_{IN} [ \frac{{R}_{b} ( {n}_{a} + 1 ) - {R}_{a} ( {n}_{b} + 1 )}{{R}_{b} - {R}_{a}} ] \qquad ( 5 )$$

where V_{IN} is the input voltage to charge pump 20, nₐ is the number of charge pump stages n for the ath-order configuration, n_{b} is the number of charge pump stages n for the bth-order configuration, and Rₐ and R_{b} are given by:

$${R}_{x} = \frac{{n}_{x}}{( \frac{m}{x} ) \times {C}_{x} \times {f}_{{clk}_{x}}} \qquad ( 6 )$$

where Cₓ is the pump capacitor and f_{clkx} is the clock frequency of clock signals CLK and \overline{CLK} of the xth-order configuration.

If second-order effects are ignored, and assuming ideal diodes having a threshold voltage of zero volts, the output voltage V_{OUT}(t) of an ath-order configuration is given by:

$${V}_{OUT} ( t ) = ( {n}_{a} + 1 ) {V}_{IN} ( 1 - {ⅇ}^{- \frac{t}{τ}} ) ( \frac{{R}_{LOAD}}{{R}_{a} + {R}_{LOAD}} ) + {V}_{INIT} {ⅇ}^{- \frac{t}{τ}} \qquad ( 7 )$$

where V_{INIT} is the initial value of V_{OUT}, R_{LOAD} is the load resistance at node V_{OUT}, and τ is a time constant given by:

$$τ = {R}_{a} {C}_{LOAD} ( \frac{{R}_{LOAD}}{{R}_{a} + {R}_{LOAD}} ) \qquad ( 8 )$$

Thus, the time required for an ath-order configuration to increase V_{OUT} from a first voltage Vₐ₁ to a second voltage Vₐ₂ is given by:

$${T}_{Va 1 - Va 2} = {RC}_{LOAD} ( \frac{{R}_{LOAD}}{{R}_{a} + {R}_{LOAD}} ) ln [ \frac{( {n}_{a} + 1 ) {V}_{IN} - {V}_{a 1} ( \frac{{R}_{a} + {R}_{LOAD}}{{R}_{LOAD}} )}{( {n}_{a} + 1 ) {V}_{IN} - {V}_{a 2} ( \frac{Ra + {R}_{LOAD}}{{R}_{LOAD}} )} ] \qquad ( 9 )$$

where C_{LOAD} is the load capacitance at node V_{OUT}.

To illustrate these techniques, an exemplary operation of charge pump 20 is described, under the following conditions:

TABLE 2

| Parameter | Value | |
|---|---|---|
| V_{IN} | 3 | V |
| V_{OUT} | 15 | V |
| C₁ = C₂ = . . . = Cₙ = C | 1 | pF |
| f_{clk} | 2 | GHz |
| R_{OUT} | 50 | kΩ |
| C_{OUT} | 10 | nF |

First, the number of required charge pump stages m may be determined from the following formula:

$$m = [ \frac{( {V}_{OUT} - {V}_{IN} )}{{V}_{IN} - ( \frac{{V}_{OUT}}{{R}_{LOAD} {C}_{stage} {f}_{clk}} )} ] \qquad ( 10 )$$

Where C_{stage} is the value of pump capacitor C. Solving equation (10) using the values in Table 2, we determine that m=8 charge pump stages 12₁, 12₂, . . . , 12₈ are required to generate an output voltage V_{OUT}=15V from an input voltage V_{IN}=3V.

The m charge pump stages may be dynamically configured in any one of multiple ways. For example, charge pump stages 12₁, 12₂, . . . , 12₈ may be dynamically configured using first-order, second-order, fourth-order and eighth-order configurations. From equations (5) and (6), above, the crossover voltages for each of these configurations are:

TABLE 3

| Configuration | n | Vₓₒᵥₑᵣ (volts) |
|---|---|---|
| first-order | 1 | 5 |
| second-order | 2 | 7 |
| fourth-order | 4 | 11 |
| eighth-order | 8 | 15 |

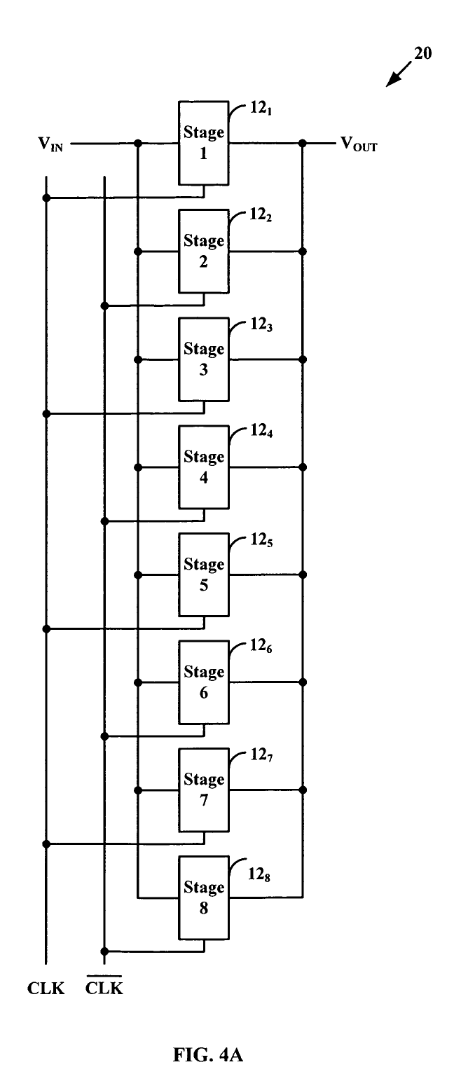

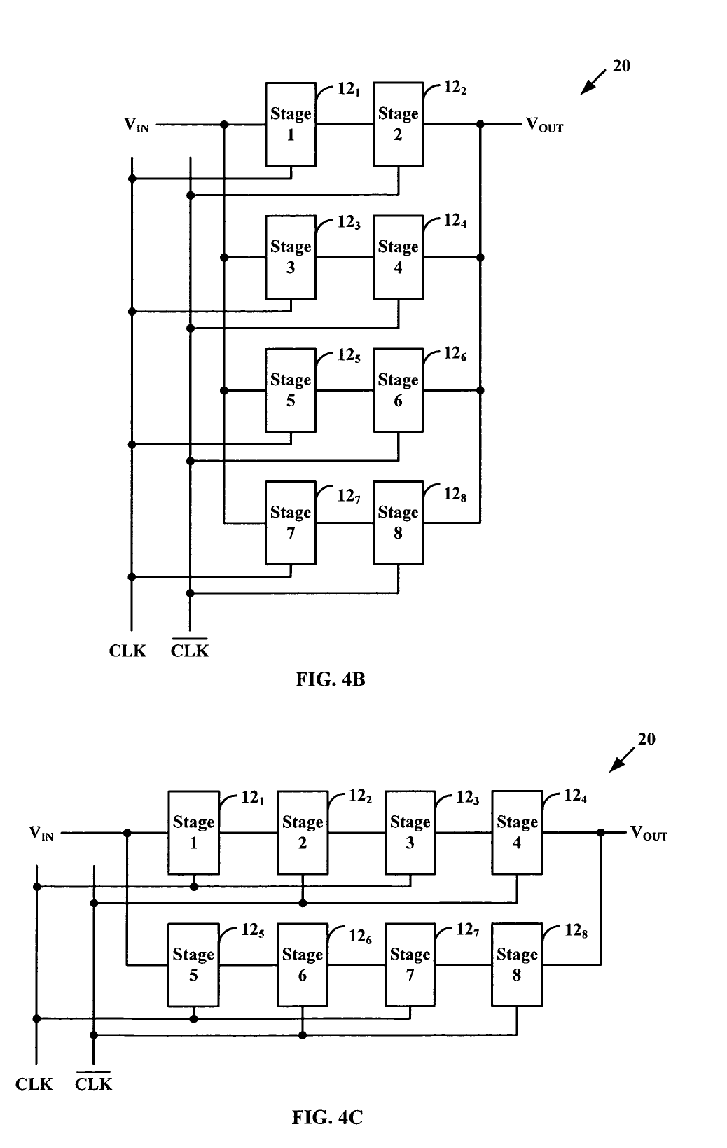

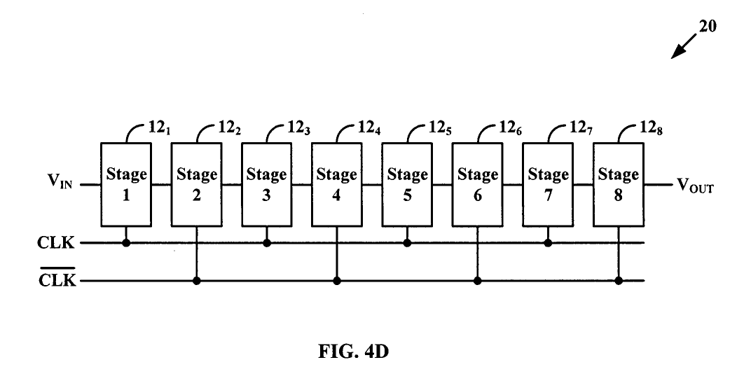

Referring now to Table 3 and FIG. 4, an exemplary technique for dynamically reconfiguring charge pump 20 is described. In particular, as illustrated in FIG. 4A, assuming that V_{OUT} has an initial value of 3V, during a first time interval T₁, 8 first-order charge pumps are coupled in parallel to increase V_{OUT} from 3 to 5V. Next, as illustrated in FIG. 4B, during a second time interval T₂, 4 second-order charge pumps are coupled in parallel to increase V_{OUT} from 5 to 7V. Next, as illustrated in FIG. 4C, during a third time interval T₃, 2 fourth-order charge pumps are coupled in parallel to increase V_{OUT} from 7 to 11V. Finally, as illustrated in FIG. 4D, during a fourth time interval T₄, 1 eighth-order charge pump is used to increase V_{OUT} from 11 to 15V. From equation (9), above, the four time intervals may be determined to be: T₁=0.69 μsec, T₂=1.75 μsec, T₃=7.18 μsec and T₄=12.46 μsec, for a total transient response time of approximately 22.08 μsec. In contrast, if a single eighth-order charge pump were used to increase V_{OUT} from 3V to 15V, the corresponding transient response time would be approximately 29.20 μsec, or approximately 32% longer than the exemplary dynamically-reconfigured charge pump.

Persons of ordinary skill in the art will understand that other techniques may be used to determine when and how charge pump 20 should be reconfigured. For example, charge pump 20 may be dynamically reconfigured to increase output current I_{OUT}, while simultaneously limiting input current requirements. Thus, in the example described above for m=8, to meet input current limits, charge pump 20 may be configured using six, first-order charge pumps during a first time interval, four, second-order charge pumps during a second time interval, two, third-order charge pumps for a third time interval, and so on. Alternatively, if m=6, charge pump 20 may be configured using 1 third-order charge pump during a first time interval, and 1 sixth-order charge pump during a second time interval. This latter technique may be used to avoid a high input current demand during the first time interval.

In addition, persons of ordinary skill in the art will understand that other techniques may be used to dynamically reconfigure charge pump circuit 20 during a transition on V_{OUT}. In particular, referring again to FIG. 2, if clock generator 22 has a variable clock frequency f_{clk}, the clock frequency may be modified along with the configuration of charge pump stages 12₁, 12₂, . . . , 12ₖ to improve the transient response of charge pump circuit 20. For example, if the output current of each charge pump stage 12₁, 12₂, . . . , 12ₖ is I_{OUT0} for f_{clk}=2 GHZ, from equation (2), above, if f_{clk} is increased to p×f_{clk}, then output current I_{OUT}=p×I_{OUT0}.

Thus, using the values from Table 2, above, with m=8, to increase V_{OUT} from 3 to 15V, charge pump 20 may be dynamically modified during the transient interval as follows: During a first during a first time interval T₁′, a single charge pump stage 12₁ may be clocked at 8×f_{clk} to increase V_{OUT} from 3 to 5V. During a second interval T₂′, a single second-order charge pump may be clocked at 4×f_{clk} to increase V_{OUT} from 5 to 7V. During a third interval T₃′, a single fourth-order charge pump may be clocked at 2×f_{clk} to increase V_{OUT} from 7 to 11V. Finally, during a fourth interval T₃′, a single eighth-order charge pump may be clocked at f_{clk} to increase V_{OUT} from 11 to 15V.

Persons of ordinary skill in the art will also understand that still other techniques may be used to dynamically reconfigure charge pump circuit 20 during a transition on V_{OUT}. For example, referring again to FIG. 2, if charge pump stages 12₁, 12₂, . . . , 12ₖ each include an array of switchable unit pump capacitors C, the size of pump capacitors C₁, C₂, C₃, . . . , Cₖ may be dynamically modified along with the configuration of the charge pump stages to improve the transient response of charge pump circuit 20. For example, with m=4, during a first time interval T₁″, a fourth-order charge pump may be configured with C₁=8 units, C₂=4 units, C₂=2 units and C₄=1 unit to increase V_{OUT} from a first voltage to an intermediate voltage. During a second time interval, T₂″, the fourth-order charge pump may be configured with C₁=1 unit, C₂=1 unit, C₂₌₁ units and C₄=1 unit to increase V_{OUT} from the intermediate voltage to a second voltage. In this regard, charge pump circuit 20 may be a dynamically-taperable charge pump.

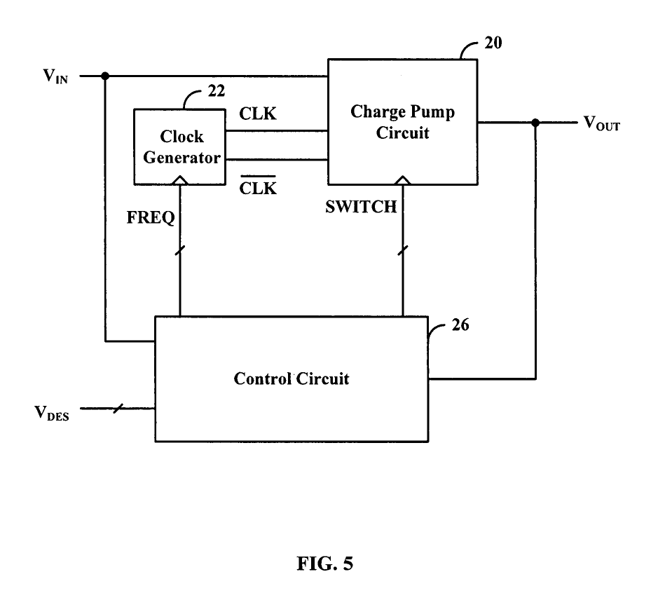

Persons of ordinary skill in the art will understand that various techniques may be used to control the reconfiguration of charge pump circuit 20. For example, as illustrated in FIGS. 2 and 5, charge pump circuit 20 may include a multi-bit input signal node SWITCH that may be used to control input switches Si₁, Si₂, . . . , Siₖ, output switches So₁, So₂, . . . , Soₖ, and coupling switches Sc₁, Sc₂, . . . , Scₖ. Additionally, clock generator 22 may include a multi-bit input signal node FREQ that may be used to control the frequency of clock signals CLK and \overline{CLK}. A control circuit 26 may be coupled to input signal V_{IN}, output signal V_{OUT} and a control signal V_{DES}, and may be used to generate control signals FREQ and/or SWITCH for controlling the output voltage and/or output current of charge pump circuit 20. V_{DES} may be a control signal that specifies a desired output voltage V_{OUT}. For example, V_{DES} may have a first value corresponding to a memory READ mode (e.g., V_{OUT}=4 V), and a second value that corresponds to a memory WRITE mode (e.g., V_{OUT}=8V). Control circuit 26 may include any well-known control circuitry that may provide closed-loop and/or open-loop control of charge pump circuit 20 and/or clock generator 22.

For example, control circuit 26 may provide closed-loop feedback control. In particular, if V_{OUT} is at a first voltage V_{A}, and control signal V_{DES} specifies that the output voltage should be a second voltage V_{B}, control circuit 26 may sense the output voltage (or current), and generate control signals FREQ and/or SWITCH to reconfigure charge pump 20 during the transition on V_{OUT}. Alternatively, control circuit 26 may provide open-loop control. In particular, during a transition on V_{OUT} from a first voltage V_{A} to a second voltage V_{B}, control circuit 26 may generate control signals FREQ and/or SWITCH to configure charge pump 20 in a first configuration for a first predetermined time period, a second configuration for a second predetermined time period, a third configuration for a third predetermined time period, and so on. This control technique may be useful at startup to reduce initial current spikes. In addition, control circuit 26 may sense the voltage (or current) at input node V_{IN}, compare the sensed voltage (or current) to a reference voltage (or current), and generate control signals FREQ and/or SWITCH to reconfigure charge pump 20 based on the deviation between the sensed value and the reference value. Persons of ordinary skill in the art will understand that this technique may be combined with other control techniques.

The foregoing merely illustrates the principles of this invention, and various modifications can be made by persons of ordinary skill in the art without departing from the scope and spirit of this invention.

1. A method for controlling a charge pump system comprising a plurality of charge pump stages, each charge pump stage coupled between an input voltage V_{IN} at an input voltage node and an output voltage V_{OUT} at an output voltage node, the method comprising:
changing a configuration of the charge pump stages during a transition on V_{OUT} from a first voltage to a second voltage.

2. The method of claim 1, wherein changing the configuration comprises coupling one of the charge pump stages to the input voltage node and the output voltage node to increase V_{OUT} to a first intermediate voltage between the first and second voltages.

3. The method of claim 1, wherein changing the configuration comprises coupling a first plurality of the charge pump stages to the input voltage node and the output voltage node to increase V_{OUT} to a first intermediate voltage between the first and second voltages.

4. The method of claim 3, wherein changing the configuration further comprises coupling a second plurality of the charge pump stages to the input voltage node and the output voltage node to increase V_{OUT} to a second intermediate voltage between the first and second voltages.

5. The method of claim 1, wherein changing the configuration comprises coupling one of the charge pump stages to the input voltage node and the output voltage node during a first time interval during the transition on V_{OUT} from the first voltage to the second voltage.

6. The method of claim 1, wherein changing the configuration comprises coupling a first plurality of the charge pump stages to the input voltage node and the output voltage node during a first time interval during the transition on V_{OUT} from the first voltage to the second voltage.

7. The method of claim 6, wherein changing the configuration further comprises coupling a second plurality of the charge pump stages to the input voltage node and the output voltage node during a second time interval during the transition on V_{OUT} from the first voltage to the second voltage.

8. The method of claim 1, wherein changing the configuration comprises controlling a number of the charge pump stages coupled to the input voltage node and the output voltage node during the transition on V_{OUT} from the first voltage to the second voltage.

9. The method of claim 1, wherein changing the configuration comprises controlling a frequency of a clock signal supplied to the charge pump stages during the transition on V_{OUT} from the first voltage to the second voltage.

10. The method of claim 9, wherein controlling the clock frequency comprises providing a first clock signal at a first frequency to the charge pump stages to increase V_{OUT} to a first intermediate voltage between the first and second voltages.

11. The method of claim 10, wherein controlling the clock frequency further comprises providing a second clock signal at a second frequency to the charge pump stages to increase V_{OUT} to a second intermediate voltage between the first and second voltages.

12. The method of claim 9, wherein controlling the clock frequency comprises providing a first clock signal at a first frequency to the charge pump stages during a first time interval during the transition on V_{OUT} from the first voltage to the second voltage.

13. The method of claim 9, wherein controlling the clock frequency further comprises providing a second clock signal at a second frequency to the charge pump stages during a second time interval during the transition on V_{OUT} from the first voltage to the second voltage.

14. The method of claim 1, wherein:
the charge pump system supplies an output current I_{OUT} at the output voltage node; and
changing the configuration maximizes the output current I_{OUT} during a transition on V_{OUT} from a first voltage to a second voltage.

15. The method of claim 1, wherein
the charge pump system receives an input current I_{IN} at the input node, and supplies an output current I_{OUT} at the output voltage node; and
changing the configuration limits input current I_{IN} requirements.

16. The method of claim 1, wherein changing the configuration comprises:
coupling a first plurality of the charge pump stages in series during a first time interval during the transition on V_{OUT} from the first voltage to the second voltage; and
coupling a second plurality of the charge pump stages in series during a second time interval during the transition on V_{OUT} from the first voltage to the second voltage.

17. A charge pump system comprising a plurality of charge pump stages, each charge pump stage coupled between an input voltage V_{IN} at an input voltage node and an output voltage V_{OUT} at an output voltage node, the charge pump system comprising:
means for dynamically controlling a configuration of the charge pump stages during a transition on V_{OUT} from a first voltage to a second voltage.

18. The system of claim 17, wherein the means for dynamically controlling comprises means for coupling one of the charge pump stages to the input voltage node and the output voltage node to increase V_{OUT} to a first intermediate voltage between the first and second voltages.

19. The system of claim 17, wherein the means for dynamically controlling comprises means for coupling a first plurality of the charge pump stages to the input voltage node and the output voltage node to increase V_{OUT} to a first intermediate voltage between the first and second voltages.

20. The system of claim 19, wherein the means for dynamically controlling further comprises means for coupling a second plurality of the charge pump stages to the input voltage node and the output voltage node to increase V_{OUT} to a second intermediate voltage between the first and second voltages.

21. The system of claim 17, wherein the means for dynamically controlling comprises means for coupling one of the charge pump stages to the input voltage node and the output voltage node during a first time interval during the transition on V_{OUT} from the first voltage to the second voltage.

22. The system of claim 17, wherein the means for dynamically controlling comprises means for coupling a first plurality of the charge pump stages to the input voltage node and the output voltage node during a first time interval during the transition on V_{OUT} from the first voltage to the second voltage.

23. The system of claim 22, wherein the means for dynamically controlling further comprises means for coupling a second plurality of the charge pump stages to the input voltage node and the output voltage node during a second time interval during the transition on V_{OUT} from the first voltage to the second voltage.

24. The system of claim 17, wherein the means for dynamically controlling comprises means for controlling a number of the charge pump stages coupled to the input voltage node and the output voltage node during the transition on V_{OUT} from the first voltage to the second voltage.

25. The system of claim 17, wherein the means for dynamically controlling comprises means for controlling a frequency of a clock signal supplied to the charge pump stages during the transition on V_{OUT} from the first voltage to the second voltage.

26. The system of claim 25, wherein the means controlling the clock frequency comprises means for providing a first clock signal at a first frequency to the charge pump stages to increase V_{OUT} to a first intermediate voltage between the first and second voltages.

27. The system of claim 25, wherein the means for controlling the clock frequency further comprises means for providing a second clock signal at a second frequency to the charge pump stages to increase V_{OUT} to a second intermediate voltage between the first and second voltages.

28. The system of claim 25, wherein the means for controlling the clock frequency comprises means for providing a first clock signal at a first frequency to the charge pump stages during a first time interval during the transition on V_{OUT} from the first voltage to the second voltage.

29. The system of claim 25, wherein the means for controlling the clock frequency further comprises means for providing a second clock signal at a second frequency to the charge pump stages during a second time interval during the transition on V_{OUT} from the first voltage to the second voltage.

30. The system of claim 17, wherein:
the charge pump system supplies an output current I_{OUT} at the output voltage node; and
the means for dynamically controlling maximizes the output current I_{OUT} during a transition on V_{OUT} from a first voltage to a second voltage.

31. The system of claim 17, wherein
the charge pump system receives an input current I_{IN} at the input node, and supplies an output current I_{OUT} at the output voltage node; and
the means for dynamically controlling limits input current I_{IN} requirements.

32. The system of claim 17, wherein the means for changing the configuration comprises:
means for coupling a first plurality of the charge pump stages in series during a first time interval during the transition on V_{OUT} from the first voltage to the second voltage; and
means for coupling a second plurality of the charge pump stages in series during a second time interval during the transition on V_{OUT} from the first voltage to the second voltage.
